(19) United States
(12) Patent Application Publication
(10) Pub. No.: US 2019/0348056 A1
(43) Pub. Date: Nov. 14, 2019

(54) FAR FIELD SOUND CAPTURING

(71) Applicant: Harman Becker Automotive Systems GmbH, Karlsbad (DE)

(72) Inventor: Markus E Christoph, Straubing (DE)

(73) Assignee: Harman Becker Automotive Systems GmbH, Karlsbad (DE)

(21) Appl. No.: 16/471,550

(22) PCT Filed: Dec. 11, 2017
(86) PCT No.: PCT/EP2017/082118

§ 371 Date: Jun. 19, 2019

(30) Foreign Application Priority Data
Jan. 4, 2017 (EP) 17150217.2

(51) Int. Cl. G10L 21/0208; H04R 1/40

(52) U.S. Cl. CPC G10L 21/0208; H04R 1/406; G10L 2021/02166; G10L 2021/02082; H04R 2430/23

(57) ABSTRACT

A system method for far field sound capturing, the method includes picking up sound to provide M≥2 microphone signals, echo cancelling processing the M microphone signals (and one or more reference signals) to provide M echo cancelled signals, and beamforming processing the M echo cancelled signals to provide B≥1 beamformed signals.

### BACKGROUND

### 1. Technical Field

The disclosure relates to a system and method (generally referred to as a “system”) for far field sound capturing.

### 2. Related Art

Systems for far field sound capturing, also referred to as far field microphones or far field microphone systems, are adapted to record sounds from a desired sound source that is positioned at a greater distance (e.g., several meters) from the far field microphone. The greater the distance between sound source and the far field microphone, however, the lower the desired sound to noise ratio is. The term “noise” in the instant case includes sound that carries no information, ideas or emotions, e.g., no speech or music. If the noise is undesired, it is also referred to as interfering noise. When speech or music is introduced into a noise-filled environment such as a home or office interior, the noise present in the interior can have an undesired interfering effect on a desired speech communication or music presentation. Noise reduction is commonly the attenuation of undesired signals but may also include the amplification of desired signals. Desired signals may he speech signals, whereas undesired signals can be any sounds in the environment which interfere with the desired signals. There have been three main approaches used in connection with noise reduction: Directional beamforming, spectral subtraction, and pitch-based speech enhancement. Systems designed to receive spatially propagating signals often encounter the presence of interference signals. If the desired signal and interferers occupy the same temporal frequency band, then temporal filtering cannot be used to separate the desired signal from interference. There exists a desire to improve noise reduction.

### SUMMARY

A system for far field sound capturing includes M≥2 microphones configured to pick up sound and to provide M microphone signals, a multi-channel acoustic echo canceller block configured to receive the M microphone signals (and one or more reference signals) and to provide M echo cancelled signal, and a (fix) beam-former block configured to receive the M echo cancelled signals and to process the M echo cancelled signals to provide B≥1 beamformed signals.

A speech pause detector includes a time-to-frequency transformation block configured to transform an input signal in the time domain to an input signal in the frequency domain, a splitter configured to split the input signal in the frequency domain into a multiplicity of intermediate signals in the frequency domain, and a multiplicity of noise estimators configured to estimate the noise contained in each intermediate signal in the frequency domain. The speech pause detector further includes a multiplicity of signal-to-noise evaluators configured to evaluate the signal to noise ratio for each input signal in the frequency domain from the multiplicity of intermediate signals in the frequency domain and the estimated noise contained in each intermediate signal in the frequency domain, a multiplicity of comparators configured to compare each signal-to-noise ratio with a pre-determined threshold to provide signal-to-noise comparison signals, a summer configured to sum up the signal-to-noise comparison signals and to provide a sum signal, and a voice activity detector configured to detect the occurrence and non-occurrence of speech signals in the sum signal and to provide a voice activity signal indicative of the occurrence and non-occurrence of speech signals.

A method for far field sound capturing, the method includes picking up sound to provide M≥2 microphone signals, echo cancelling processing the M microphone signals (and one or more reference signals) to provide M echo cancelled signals, and beamforming processing the M echo cancelled signals to provide B≥1 beamformed signals.

A speech pause detection method includes transforming an input signal in the time domain to an input signal in the frequency domain splitting the input signal in the frequency domain into as multiplicity of intermediate signals in the frequency domain, estimating the noise contained in each intermediate signal in the frequency domain, and evaluating the signal to noise ratio for each input signal in the frequency domain from the multiplicity of intermediate signals in the frequency domain and the estimated noise contained in each intermediate signal in the frequency domain. The method further includes comparing each signal-to-noise ratio with a pre-determined threshold to provide signal-to-noise comparison signals, summing up the signal-to-noise comparison signals and providing a sum signal, and detecting the occurrence and non-occurrence of speech signals in the sum signal and to provide a voice activity signal indicative of the occurrence and non-occurrence of speech signals.

Other systems, methods, features and advantages will be, or will become, apparent to one with skill in the art upon examination of the following detailed description and appended figures. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic diagram illustrating an exemplary far field microphone system.

FIG. 2 is a schematic diagram illustrating an exemplary acoustic echo canceller applicable in the far field microphone system shown in FIG. 1.

FIG. 3 is a schematic diagram illustrating an exemplary filter and sum beamformer.

FIG. 4 is a schematic diagram illustrating an exemplary beam steering block.

FIG. 5 is a schematic diagram illustrating a simplified structure of an adaptive beamformer with adaptive post filter without adaptive blocking filter.

FIG. 6 is a schematic diagram of an exemplary far field microphone with an exemplary speech pause detection block.

FIG. 7 is a schematic diagram illustrating an exemplary speech pause detection block operating in the frequency domain.

The Figures describe concepts in the context of one or more structural components. The various components shown in the figures can be implemented in any manner including, for example, software or firmware program code executed on appropriate hardware, hardware and any combination thereof lax some examples, the various components may reflect the use of corresponding components in an actual implementation. Certain components may be broken down into plural sub-components and certain components can be implemented in an order that differs from that which is illustrated herein, including a parallel manner.

### DETAILED DESCRIPTION

It has been found that desired signals and interfering signals usually originate from different spatial locations. Therefore, beamforming techniques may be used to improve signal-to-noise ratios in audio applications. Common beamforming techniques include the delay and sum techniques, adaptive finite impulse response (FIR) filtering techniques using algorithms such as the Griffiths-Jim algorithm, and techniques based on the modeling of the human binaural hearing system.

Beamformers can be classified as either data independent or statistically optimum, depending on how the weights are chosen. The weights in a data independent beamformer do not depend on the array data and are chosen to present a specified response for all signal/interference scenarios. Statistically optimum beamformers select the weights to optimize the beamformer response based on statistics of the data. The data statistics are often unknown and may change with time, so adaptive algorithms are used to obtain weights that converge to the statistically optimum solution. Computational considerations dictate the use of partially adaptive beamformers with arrays composed of large numbers of sensors. Many different approaches have been proposed for implementing optimum beamformers. In general, the statistically optimum beamformer places nulls in the directions of interfering sources :in an attempt to maximize the signal to noise ratio at the beamformer output.

In many applications the desired signal may be of unknown strength and may not always be present. In such applications, the correct estimation of signal and noise covariance matrices in the maximum signal-to-noise ratio (SNR) is not possible. Lack of knowledge about the desired signal may prevent utilization of the reference signal approach. These limitations can be overcome through the application of linear constraints to the weight vector. Use of linear constraints is an approach that permits extensive control over the adapted response of the beamformer. A universal linear constraint design approach, however, does not exist and in many applications a combination of different types of constraint techniques may be effective. However, attempting to find either a single best way or a combination of different ways to design the linear constraint limits the use of techniques that rely on linear constraint design for beamforming applications.

Generalized sidelobe cancelling (GSC) technology presents is an alternative approach for addressing the drawbacks associated with the linear constraint design technique for beamforming applications. Essentially, GSC is a mechanism for changing a constrained minimization problem into unconstrained form. GSC leaves the desired signals from a certain direction undistorted, while, at the same time, undesired signals radiating from other directions are suppressed. However, GSC uses a two path structure: a desired signal path to realize a (fix) beam former pointing to the direction of the desired signal, and an undesired signal path that ideally adaptively generates a pure noise estimate, which is subtracted from the output signal of the fix beamformer, thus increasing its signal-to-noise ratio (SNR) by suppressing noise.

The undesired signal path, i.e. the path for the estimation of noise, may be realized in a two-part approach. A first stage of the undesired signal path removes or blocks remaining components of the desired signal from the input signals of this stage, which is, e.g., an adaptive blocking filter in case of a single input, or an adaptive blocking matrix if more than one input signal is used. A second stage of the undesired signal path may further include an adaptive (multi-channel) interference canceller (AIC) in order to generate a single-channel, estimated noise signal, which is then subtracted from the output signal of the desired signal path, e.g., an optionally time delayed output signal of the fix beamformer. Thus, the noise contained in the optionally time delayed output signal of the fix beamformer can be suppressed, leading to a better SNR, as the desired signal component ideally would not be affected by this processing. This holds true if and only if all desired signal components within the noise estimation could successfully be blocked, which is rarely the case in practice, and thus represents one of the major drawbacks related to current adaptive be am forming algorithms.

Acoustic echo cancellation can be achieved, e.g., by subtracting an estimated echo signal from the total sound signal. To provide an estimate of the actual echo signal, algorithms have been developed that operate in the time domain and that may employ adaptive digital filters processing time-discrete signals. Such adaptive digital filters operate in such a way that network parameters defining the transmission characteristics of the filter are optimized with reference to a preset quality function. Such a quality function is realized, for example, by minimizing the average square errors of the output signal of the adaptive network with reference to a reference signal.

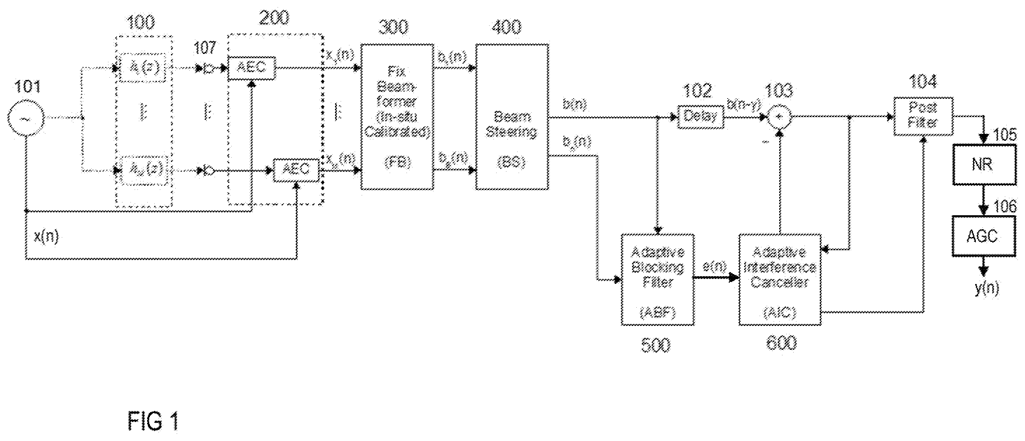

Referring now to FIG. 1, in an exemplary far field sound capturing system, sound, which corresponds to a source signal x(n) with n being a (discrete) time index, from a desired sound source 101, is radiated via one or a plurality of loudspeakers (not shown), travels through the room, where it is filtered with the corresponding room impulse responses (RIRs) 100 having transfer functions h₁(z), . . . , h_{M}(z), wherein z being frequency index, and may eventually be corrupted by noise, before the resulting sound signals are picked up by M (M is an integer, e.g., 2, 3 or more) microphones 107 which provide M microphone signals. The exemplary far field sound capturing system shown in FIG. 1 includes an acoustic echo cancellation (AEC) block 200 providing M echo canceled signals x₁(n) . . . x_{M}(n), a subsequent fix beamformer (FR) block 300 providing B (B is an integer, e.g., 1, 2 or more) beamformed signals b₁(n) . . . b_{B}(n), and a subsequent beam steering (BS) block 400 which provides a desired-source beam signal b(n), also referred to herein as positive-beam output signal b(n), and, optionally, an undesired-source beam signal bₙ(n), also referred to herein as negative-beam output signal bₙ(n). An optional undesired signal (negative-beam) path following behind the BS block 400 and supplied with the undesired-source beam signal bₙ(n) includes an optional adaptive blocking filter (ABF) block 500 providing an error signal e(n) and a subsequent adaptive interference canceller block 600. Alternatively, the original M microphone signals or the M output signals of the AEC block 200 or the B output signals of the FB block 300 may be used as input signals to the ABM block 500 optionally overlaid with the undesired-source beam signal bₙ(n), establishing an optional multichannel ABM block as well as an optional multichannel AIC block.

A desired-source beam signal (positive-beam) path, which comes next to the beam steering block 400 and which is supplied with the desired-source beam signal b(n), includes an optional delay block 102, a subsequent subtractor block 103 and a subsequent (adaptive) post filter block 104. An optional speech pause detector 700 may be connected downstream of the adaptive post filter block 104 as well as an optional noise reduction (NR) block 105 and an optional automatic gain control (AGC) block 106, each of which, if present, may be connected upstream of the speech pause detector 700. It is noted that the AEC block 200, instead of being connected upstream of the FB block 300, may be connected downstream thereof, which may be beneficial if B<M, i.e., the number of beamformers in the FB block 300 is smaller than the number of microphones. Further, the AEC block may be split into a multiplicity of sub-blocks (not shown), e.g., short-length sub-blocks for each microphone signal and a long-length sub-block (not shown) downstream of the BS block for the desired-source beam signal and optionally another long-length sub-block (not shown) for the undesired-source beam signal. Further, the system is applicable not only in situations with only one source as shown but can be adapted for use in connection with a multiplicity of sources. For example, if stereo sources that provide two uncorrelated signals are employed, the AEC blocks may be substituted by stereo acoustic echo canceller (SAEC) blocks (not shown).

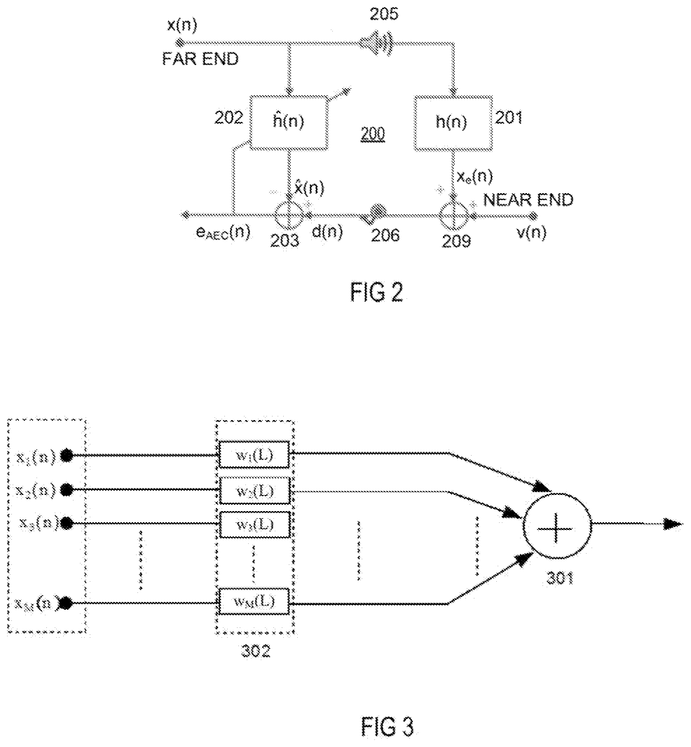

As can be seen from FIG. 1, N(=1) source signals x(n), filtered by the N×M RIRs, and possibly interfered by noise, serve as an input to the AEC blocks 200. FIG. 2 depicts an exemplary realization of a single microphone (206) single loudspeaker (205) AEC block 200. As would be understood and appreciated by those skilled in the art, such a configuration can be extended to include more than one microphone 206 and/or more than one loudspeaker 205. A far end signal, which is the source signal x(n), travels via loudspeaker 205 through an echo path 201 having the transfer function (vector) h(n)=(h₁, . . . , h_{M}) to provide an echo signal xₑ(n). This signal is added at a summing node 209 to a near-end signal v(n) which may contain both background noise and near-end speech to generate an electrical microphone (output) signal d(n). An estimated echo signal \hat{x}ₑ(n) provided by an adaptive filter block 202 is subtracted from the microphone signal d(n) at a subtracting node 203 to provide an error signal e_{AEC}(n). A goal of the adaptive filter 202 is to minimize the error signal e_{AEC}(n).

A FIR filter 20.2 with transfer function ĥ(n) of order L−1, wherein L is a length of the FIR filter, is used to model the echo path. The transfer function ĥ(n) is given as

[ĥ(0, n), . . . , ĥ(L−1, n), ]^{T}

The desired microphone signal d(n) at block 203 for the adaptive filter is given as

d(n)=x^{T}(n)h(n)+v(n),

wherein x(n)=[x(n) x(n−1) . . . x(n−L−1)]^{T} is a real-valued vector containing L (L is an integer) most recent time samples of the input signal, x(n), and v(n), i.e., the near-end signal which may include noise. Applying again the previous notations, the feedback/echo error signal is given as

e_{AEC}(n)=d(n)−x^{T}(n−1)\hat{h}(n)=x^{T}(n)[\hat{h}(n)]+v(n),

wherein vectors h(n) and ĥ(n) include the filter coefficients representing the acoustical echo path and its estimation by the adaptive filter coefficients at time n. The vector ĥ(n) is estimated using e.g. the Least Mean Square (LMS) algorithm or any state-of the art recursive algorithm. The LMS update using a step size of μ(n) of the LMS-type algorithm is expressed as

\hat{h}(n)=ĥ(n−1)+μ(n)x(n)e(n).

A simple yet effective beamforming technique is the delay-and-sum (DS) technique. Referring again to FIG. 1, the outputs of AEC blocks 200 serve as inputs xᵢ(n), with i=1, . . . , M, to the fix beamformer block 300. A general structure of a fix filter and sum (FS) beamformer block 300, which includes filters 302 with transfer functions wᵢ(L) with i=1, . . . M, and wᵢ(L)=[wᵢ(0), . . . , wᵢ(L−1)], L being the length of filters within the FB, is shown in FIG. 3. In the case that the filter blocks 302 implement desired (factual) delays, the output beamformer signals bⱼ(n) with j=1, . . . , B, are given as

$${b}_{j} ( n ) = \frac{1}{M} {\sum }_{i = 1}^{M} {x}_{i} ( n - {τ}_{i , j} ) ,$$

wherein M is the number of microphones. For each (fix) beamformer output signal bⱼ(n) with j=1, . . . . , B each microphone has a delay τ_{i,j} relative to each other. The FS beamformer may include a summer 301 which receives the input signals xᵢ(n) via filters 302 having the transfer functions wᵢ(L).

Referring again to FIG. 1, the beamformer signals bⱼ(n) output by the fix FS beamformer block 300 serve as an input to the BS block 400. Each signal from the fix beamformer block 300 is taken from a different room direction and may have a different SNR level. The input signals bⱼ(n) of the BS block 400 may contain low frequency components such as low frequency rumble, direct current (DC) offsets and unwanted vocal plosives in case of speech signals. Therefore, these artifacts that may impinge on the input signal bⱼ(n) of the BS block 400 are desired to be removed.

Alternatively, the beam pointing to the undesired signal (e.g., noise) source, i.e. the undesired-signal beam, may be approximated based on the beam pointing to the desired sound source, i.e. the desired-source beam, by letting it point in the opposite direction of (or any other fixed direction relative to and different from) the beam pointing to the desired source, which would result in a system using less resources and also in beams having exactly the same time variations. Further, this allows both beams to never point in the same direction.

Alternatively, instead of just taking the beam pointing in the desired-source direction (positive beam) as a basis, summing it up with its neighboring beams may form a basis for generating a positive-beam output signal, since all of these beams include a high level of desired signals, which are correlated to each other and would as such be amplified by the summation. On the other hand, noise parts contained in the three neighboring beams are merely uncorrelated to each other and will as such be suppressed by the summation. As a result, the final output signal of the three neighboring beams will exhibit an improved SNR.

010231 The beam pointing in the undesired-source direction (negative beam) can alternatively be generated by using all output signals of the FB block 300 except the one representing the positive beam. This leads to an effective directional response having a spatial zero in the direction of the desired signal source. Otherwise, an omnidirectional character is applicable, which may be beneficial since noise usually enters the microphone array also in an omnidirectional way, and only rarely in a directional form.

Further, the optionally delayed, desired signal from the BS block 400 forms the basis for the output signal and as such is input into the optional adaptive post filter 104. The adaptive post filter 104, which is controlled by the MC block 600 and which delivers a filtered output signal, can optionally be input into subsequent single channel noise reduction block (e.g., NR block 105 in FIG. 1), which ma implement the known spectral subtraction method, and into an optional (e.g., final) automatic gain control block (e.g., AGC block 106 in FIG. 1).

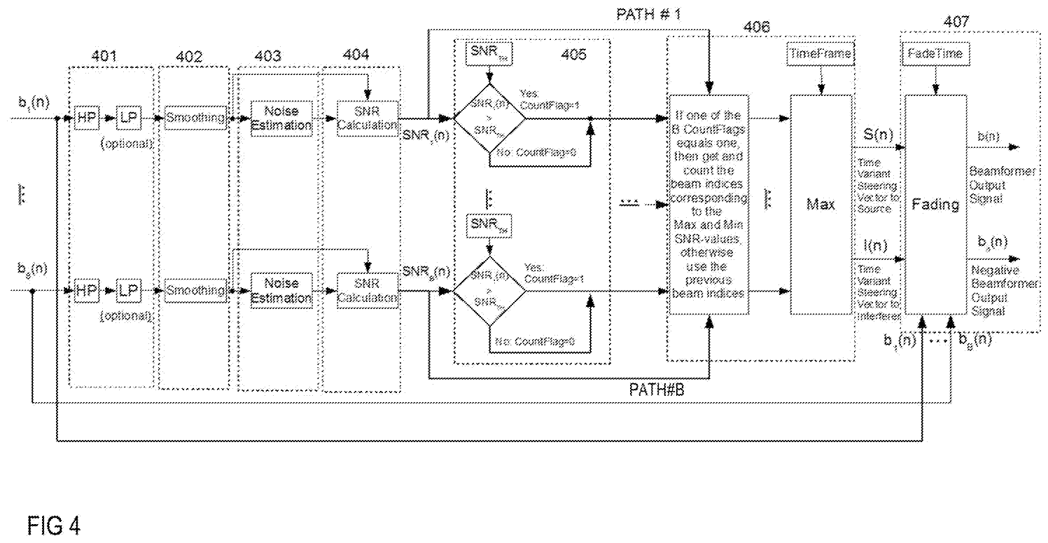

Referring to FIG. 4, in BS block 400 positive beam signals bⱼ(n) are filtered using a (high pass and an optional low pass) filter block 401 in order to block signal components that are either affected by noise or do not contain useful signal components, e.g., speech signal components. The output from filter block 401 may have amplitude variations due to noise that may introduce rapid, random changes in amplitude from point to point within the beam signal b₂(n). In this situation, it may be useful to reduce noise, e.g., by a process performed in a subsequent smoothing block 402 as shown in FIG. 4.

The filtered signals from filter block 401 are smoothed by applying, e.g., a low pass infinite impulse response (IIR) filter or an moving average (MA) finite impulse response (FIR) filter (both not shown) in smoothing block 402, thereby reducing the high frequency components and passing the low-frequency components with little change. The smoothing block 402 outputs a smoothed signal that may still contain some level of noise and thus, may cause noticeable sharp discontinuities as described above. The level of voice signals typically differs distinctly from the variation of the level of background noise, particularly due to the fact that the dynamic range of the level change of voice signals is wider and occurs in much shorter intervals than the level change of background noise. A linear smoothing filter in a noise estimation block. 403 would therefore smear out the sharp variation in the desired signal, e.g., music or voice signal, as well as filter out the noise. Such smearing of a music or voice signal is unacceptable in many applications, therefore a non-linear smoothing filter (not shown) may be applied to the smoothed signal in noise estimation block 403 to suppress the artifacts mentioned above. The data points in output beam signal bⱼ(n) of the smoothing block 402 are modified in a way that individual points with a higher amplitude than the immediately adjacent points (presumably because of noise) are reduced, and points that with a lower amplitude than the adjacent points are increased. This leads to a smoother signal (and a slower step response to signal changes).

Next, based on the smoothed signal from smoothing block 402 and the estimated background noise signal from noise estimation block 403, the variations in the SNR value can be determined (e.g., calculated). By the variations in the SNR, a noise source can be differentiated from a desired speech or music signal. For example, a low SNR value may represent a variety of noise sources such as an air-conditioner, a fan, an open window, or an electrical device such as a computer etc. The SNR may be evaluated in a time domain or in a frequency domain or in a sub-band frequency domain.

In a comparator block 405, the output SNR value from block 404 is compared with a pre-determined threshold. If the current SNR value is greater than a pre-determined threshold, a flag indicating, e.g., a desired speech signal will be set to, e.g., ‘1’, Alternatively, if the current SNR value is less than a pre-determined threshold, a flag indicating a undesired signal such as noise from an air-conditioner, fan, an open window, or an electrical device such as a computer will be set to, e.g., ‘0’.

SNR values from blocks 404 and 405 are passed to a controller block 406 via paths #1 to path #B. A controller block 406 compares the indices of a plurality of SNR (both low and high) values collected over time against the status flag in comparator block 405. A histogram of the maximum and minimum values is collected for a pre-determined time duration. The minimum and maximum values in a histogram are representative of at least two different output signals. At least one signal is directed towards a desired source denoted by S(n) and at least one signal is directed towards an interference source denoted by I(n).

If the indices for low and high SNR values in controller block 406 change over time, a fading process may be initiated that allows for a smooth transition from one to the other output signal, without generating acoustic artifacts. The outputs of the BS block 400 represent desired-signal and optionally undesired-signal beams selected over time. Here, the desired-signal beam represents the FB output (positive beam signal b(n)) having the highest SNR. Optionally, an undesired beam may represent the FB output (negative beam signal bₙ(n)) having the lowest SNR.

The outputs of BS block 400 contain a signal with high SNR (positive beam) which can be used as a reference by the optional adaptive blocking filter (ABF) block 500 and optional an additional one with a low SNR (negative beam), forming a second input signal for the optional ABF block 500. The ABF filter block 500 may use least mean square (LMS) algorithm controlled filters to adaptively subtract the signal of interest, represented by the reference signal b(n) (representing the desired-source beam) from the signal bₙ(n) (representing the undesired-source beam) and provides error signal(s) eᵢ(n). Error signal(s) eᵢ(n) obtained from ABF block 500 is (are) passed to the adaptive interference canceller (AIC) block 600 which adaptively removes the signal components that are correlated to the error signals from the beamformer output of the fix beamformer 300 in the desired-signal path. As already mentioned, other signals can alternatively or additionally serve as input to the ABM block. Furthermore, the adaptive beamformer block, which may optionally include ABM, AIC and APF blocks, can be partly or totally omitted.

First, AIC block 600 computes an interference signal using an adaptive filter (not shown). Then, the output of this adaptive filter is subtracted from the optionally delayed (with delay 102) reference signal, which may be the positive beam signal b(n), by a subtractor 103 to eliminate the remaining interference and noise components in the reference signal b(n). Finally, the adaptive post filter 104 may be connected downstream of subtractor 103 for the reduction of statistical noise components (i.e., signals not having a distinct autocorrelation). As in the ABF block 500, the filter coefficients in the AIC block 600 may be updated using the adaptive LMS algorithm. The norm of the filter coefficients in at least one of AIC block 600, ABF block 500 and AEC blocks may be constrained to prevent them from growing excessively large.

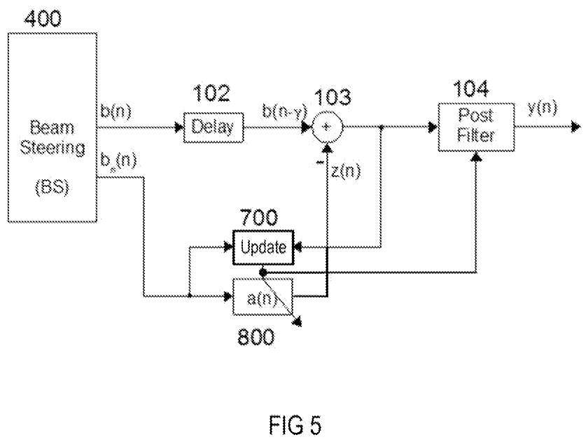

FIG. 5 illustrates an exemplary system for eliminating noise from the desired-source beam (positive beam) signal b(n). Thereby, the noise component included in the signal b(n), represented by signal zᵢ(n) in FIG. 5, is provided by an adaptive system 700 and subtracted by adder 103 from the optionally delayed by way of delay 102, desired signal b(n−γ), to reduce to a certain extent undesired noise contained therein. As reference signal for the adaptive filter 700, i.e., the negative beam signal bₙ(n), representing the undesired-source beam, which ideally only contains noise and no useful signal such as speech, is used. The known NLMS algorithm ma be used to filter noise from the desired-source beam signal b(n) from the BS block 400. The noise component in the desired-source beam signal b(n) is estimated using adaptive system block 700. The estimated noise in the desired signal b(n) is subtracted from the optionally delayed desired signal b(n−γ), by adder 103 to reduce further noise in the desired-source beam signal b(n). The undesired-source beam signal bₙ(n) will be used as noise reference signal for the adaptive system block 700 to eliminate any residual noise in the desired-source beam signal b(n). This will in turn increase the signal-to-noise (SIR) ratio of the desired-source beam signal b(n). The system shown in FIG. 5 employs no optional ABF or ABM blocks since an additional blocking of signal components of the undesired signal, performed by the ABF or ABM blocks, may be omitted if it hardly increases the quality of the pure noise signal in comparison to the desired signal b(n−γ). Thus, the ABF and/or ABM blocks may be omitted without deteriorating the performance of the adaptive beamformer, depending on the quality of the undesired-source beam signal bₙ(n).

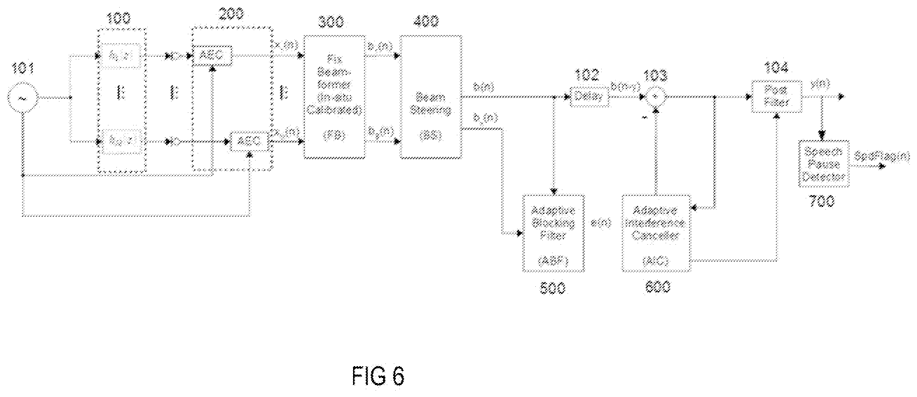

As depicted in FIG. 6, the desired output speech signal y(n) of the block 104 may servo as an input to a speech pause detector (SPD) block 700. An SPD block such as SPD block 700 may be used in a far field microphone system as shown or in any other appropriate application.

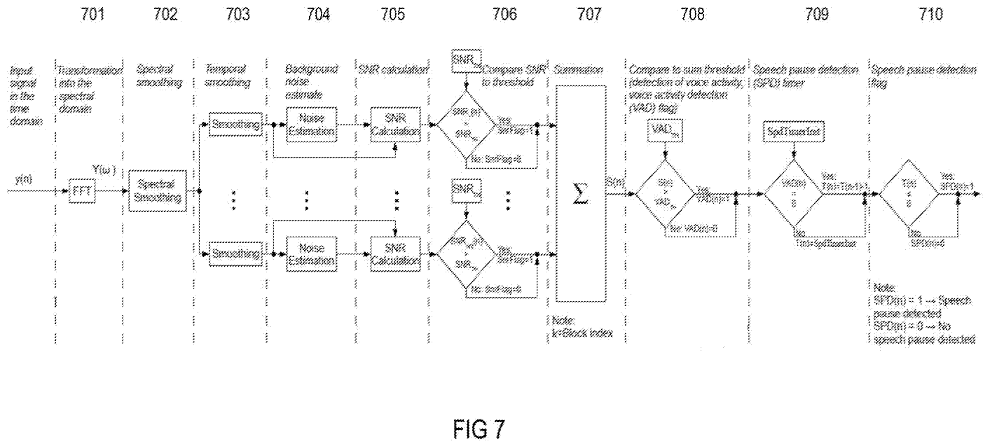

Referring to FIG. 7, the speech pause detector (SPD) block 700 may transform an input signal y(n) from the time domain into the frequency domain by a time-frequency transformation block 701 The spectral components of the input signal can be obtained by a variety of ways, including band pass filtering and Fourier transformation. In one approach, a discrete or fast Fourier transform may be utilized to transform sequential blocks of N points of the input signal. A window function, such as a Hanning window, may he applied, in which case an overlap of N/2 points can be used. A Discrete Fourier Transform (DFT) can be utilized at each frequency bin in the input signal. Alternatively, a Fast Fourier Transform (FFT) can he utilized over the whole frequency band occupied by the input signal. The spectrum is stored for each frequency bin within the input signal hand.

In the present example, time-frequency transformation block 701 applies a fast Fourier transform (FFT) with optional windowing (not shown) to input signal y(n) in the time domain to generate a signal Y(ω) in the frequency domain. The signal Y(ω) is optionally smoothed by spectral smoothing block 702 using a moving average filter of appropriate length and by applying a window function. For the window function, a Hanning window or any other window function is applicable.

A drawback of the (optional) spectral smoothing is that it accounts for a plurality of frequency bins, which reduces the spectral resolution. In order to overcome the drawbacks associated with spectral smoothing, the output of the spectral smoothing block 702 is further smoothed by using a temporal smoothing block 703. The temporal smoothing block 703 combines frequency bin values over time to reduce the temporal dynamics in the output signal of the block 702.

The temporal smoothing block 703 outputs temporally smoothed signal that may still contain impulsive distortions as well as background noise. A noise estimation block 704 is connected downstream of the temporal smoothing block 703 to smear out impulsive distortions such as speech in the output of the temporal smoothing block 703 to eventually estimate the current background noise. In order to reduce or avoid smearing of a desired signal such as music or voice signals, non-linear smoothing (not shown) may be employed in noise estimation block 704.

Based on the smoothed signal from temporal smoothing block 703 and the estimated quasi stationary background noise signal from the noise estimation block 704, variations in the SNR can be determined (e.g., as frequency distribution of SNR values). By variations of the SNR, a noise source can be differentiated from a desired speech or music signal. For example, a low SNR value may represent a variety of noise sources such as an air-conditioner, fan, an open window, or an electrical device such as a computer etc. The SNR may be evaluated in the time domain or in the frequency domain or in the sub-band domain.

In a comparator block 706, the output SNR value from block 405 is compared with a pre-determined threshold. If the current SNR value is greater than a pre-determined threshold, a flag indicating, e.g., a desired speech signal will be set to, e,g, ‘1’. If the current SNR value is less than a pre-determined threshold, a flag indicating an undesired signal such as noise from an air-conditioner, fan, an open window, or an electrical device such as a computer will be set to e.g., ‘0’.

SNR values from block 706 are passed to a summation block 707. The summation block 707 sums the spectral flags from block 706 and outputs at least one time varying signal S(n). The output signal S(n) from block 707 is passed to a comparator block 708. In a comparator block 708, the output signal S(n) from block 707 is compared with yet another pre-determined threshold. If the current value of the output signal S(n) is greater than a pre-determined threshold, a flag indicating voice activity will be set to, e.g., ‘1’. Alternatively, if the current value of output signal (n) is less than a pre-determined threshold, a flag indicating a voice activity will be set to, e.g., ‘0’.

The output signal of the comparator block 708 may be representative of voice inactivity. The output of the comparator block 708 is passed to the speech pause detection (SPD) timer block 709. The SPD timer block 709 may use a counter 710 to count the number (count) T(n) of flags ‘0’ from comparator block 708 indicating a voice inactivity or pauses during the speech. If SPD timer block 709 encounters voice inactivity or pauses, the count T(n) will be decremented by one, otherwise the count T(n) will be reset to, e.g., its initialization value.

The output of the SPD timer block 710 is passed on to the speech pause detection (SPD) block 710. In the SPD timer block 710, output count T(n) is compared with pre-determined threshold. If the current count T(n) is less than a pre-determined threshold, a flag indicating e.g., a speech pause will be set to ‘1’. If the current count T(n) is greater than pre-determined threshold, a flag indicating a pause in a speech will be set to ‘0’ indicating voice activity. As already mentioned the method outlined above can also be realized in the time domain.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The described methods and associated actions may also be performed in various orders in addition to the order described in this application, in parallel, and/or simultaneously. The described systems are exemplary in nature, and may include additional elements and/or omit elements.

For example, in a far-field sound capturing system as described above, the beam-steering block could alternatively be based on some or all of the M microphone or error signals provided by the acoustic echo canceller, i.e. signals before or after the acoustic echo canceller or before or after an optional residual echo suppressor in the acoustic echo canceller. Alternatively or additionally to detecting the beam of sound wave pointing towards a desired source, a beam of sound wave pointing towards an undesired source may be used as main beam. The system may further include an optional adaptive blocking filter or adaptive blocking matrix configured to statically or adaptively block useful signal parts within its input signals) connected upstream of the adaptive interference canceller. The adaptive interference canceller may alternatively or additionally be configured to provide the estimated noise signal based not (only) on the M echo cancelled signals, but (also) on other signals such as, e.g., the undesired-source beam signal.

Instead, of the order of blocks described above, which is the acoustic echo canceller block, the subsequent (fix) beamformer block, the subsequent beamsteering block and finally the adaptive interference canceller, some signal processing blocks can be exchanged or omitted, in particular the fix beamformer block and the acoustic echo canceller block or parts of it, which would also allow for a possible order of (fix) beamformer block, followed by the acoustic echo canceller block, then the beamsteering block and optionally the adaptive interference canceller. A further optional structure includes, as an input stage, a shorter acoustic echo canceller block configured to process each of the M microphone signals and a single-channel, potentially longer acoustic echo canceller block configured to process the positive-beam output signal and, optionally, another single-channel, potentially longer acoustic echo canceller block configured to process the undesired-source beam signal.

In order to save resources, the acoustic echo canceller block(s) may be arranged in the most efficient position, e.g., if M<B, as an input stage, and if M>B, downstream of the beamforming block or in split structure as described above. As a further alternative, the (fix) beamformer block may be a (fix) modal beamformer, which can be more easily implemented as different “look angles” and can be realized with only an additional rotation matrix, implemented, e.g., by way of a simple multiplication for each eigenbeam, after which the most suitable one can be dynamically fine-tuned since the eigenbeams are rotatable.

Further, the beamsteering block may, in its simplest implementation, only provide the desired-source beam signal, which then can serve as the first and most simple output signal of the far field sound capturing system All other signal processing units such as, for example, an adaptive beamformer which may be formed by the adaptive interference canceller in connection with the optional adaptive blocking filter or matrix block, an adaptive post filter block, a noise reduction block, an automatic gain control block and a speech pause detector block are optional. These optional blocks can be put together in any combination. Thus, the positive-beam output signal may, for example, first run through the automatic gain control block, or first through the noise reduction and then through the automatic gain control block. Further, the adaptive beamformer may be utilized with or without the adaptive blocking filter or matrix block. A multiplicity of other combinations are applicable. If a (fix) modal beamformer is used, the beamsteering block may be omitted since the (fix) modal beamformer may then be configured to automatically (dynamically) or adaptively orient itself into the direction of the respective source and, thus, already be able to provide the respective beam output signal.

In speech pause detectors such as the one described above, alternatively numerous adjacent bins may be combined to provide a frequency resolution similar to that of the human ear (e.g., according to Bark scale, Mel scale, ERB scale, etc.). This would diminish complexity by correspondingly reducing the number of processing steps. Furthermore, the speech pause detector has only been described up to the point of voice activity recognition, the final part (timer and decider) have been left out. The speech pause detector may not only be implemented in the frequency domain but can also be realized in the time domain. Moreover, this system can not only detect speech pauses, but also in turn voice activity. The different variations of the above-described speech pause detector are accordingly applicable also in stand-alone applications.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects.

The embodiments of the present disclosure generally provide for a plurality of circuits, electrical devices, and/or at least one controller. All references to the circuits, the at least one controller, and other electrical devices and the functionality provided by each, are not intended to be limited to encompassing only what is illustrated and described herein. While particular labels may be assigned to the various circuit(s), controller(s) and other electrical devices disclosed, such labels are not intended to limit the scope of operation for the various circuit(s), controller(s) and other electrical devices. Such circuit(s), controller(s) and other electrical devices may be combined with each other and/or separated in any manner based on the particular type of electrical implementation that is desired.

It is recognized that any controller as disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any controller as disclosed utilizes any one or more microprocessors to execute a computer-program that is embodied in a non-transitory computer readable medium that is programmed to perform any number of the functions as disclosed. Further, any controller as provided herein includes a housing and the various number of microprocessors, integrated circuits, and memory devices ((e.g. FLASH, random access memory (RAM), read only memory (ROM), electrically programmable read only memory (EPROM), electrically erasable programmable read only memory (EEPROM)) positioned within the housing. The controller(s) as disclosed also include hardware based inputs and outputs for receiving and transmitting data, respectively from and to other hardware based devices as discussed herein.

While various embodiments of the invention have been described, it will be apparent to those of ordinary skilled in the art that many more embodiments and implementations are possible within the scope of the invention. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof.

1. A system for far field sound capturing comprising:
M>2 microphones configured to pick up sound and to provide M electrical microphone signals:
a multi-channel acoustic echo canceller configured to receive the M microphone signals and to provide M echo cancelled signals; and
a beam former configured to receive the M echo cancelled signals and to process die M echo cancelled signals to provide B≥1 beamformed signals.

2. The system of claim 1, further comprising a beamsteerer configured to receive and process the B beamformed signals, wherein processing the B beamformed signals comprises detecting a desired-source beam signal, the desired-source beam signal representing a beam of sound wave pointing towards a desired source.

3. The system of claim 2, wherein processing the B beamformed signals further comprises detecting an undesired-source beam signal, the undesired-source beam signal representing a beam of sound wave pointing towards an undesired source.

4. The system of claim 2, further comprising
an adaptive interference canceller configured to provide an estimated noise signal based on at least one of the desired-source beam signal and undesired-source beam signal; and
a subtractor configured to subtract the estimated noise signal from the desired beam signal to provide an output signal.

5. The system of claim 2, wherein processing the B beamformed signals further comprises evaluating the signal-to-noise ratios of the B beamformed signals to identify the highest signal-to-noise ratio and detecting the desired-source beam signal based on the highest signal-to-noise ratio.

6. The system of claim 3, wherein processing the B beamformed signals further comprises evaluating the signal-to-noise ratios of the B beamformed signals to identify the lowest signal-to-noise ratio and detecting the undesired-source beam signal based on the lowest signal-to-noise ratio.

7. The system of claim 3, wherein processing the B beamformed signals further comprises detecting the undesired-source beam signal based on the desired-source beam signal, in that the undesired-source beam signal represents a beam of sound wave pointing in an opposite direction of the desired source.

8. The system of claim 4, further comprising an adaptive blocking filter operatively coupled with the beamsteerer and the adaptive interference canceller, the adaptive blocking filter configured to process at least one of the desired-source beam signal and undesired-source beam signal from the beamsteerer and to provide an error signal to the adaptive interference canceller, and the adaptive interference canceller configured to provide an estimated noise signal based on the error signal.

9. The system of claim 1, further comprising at least one of an adaptive post filter, a speech pause detector, a noise reduction filter and an automatic gain controlled amplifier, each connected downstream of the subtractor, wherein the adaptive post filter is configured to provide a filtered output signal with reduced statistical broadband noise, the automatic gain controlled amplifier is configured to control a signal level of the output signal and the speech pause detector is configured to detect the occurrence and non-occurrence of speech signals in the output signal or filtered output signal.

10. The system of claim 4, further comprising a delay element operatively coupled with the beamsteerer and the subtracts and configured to timely delay the desired-source beam signal supplied to the subtractor by the beamsteerer.

11-22. (canceled)

23. A method for far field sound capturing, the method comprising;
picking up sound to provide M≥2 electrical microphone signals;
echo cancelling processing the M microphone signals to provide M echo cancelled signals; and
beamforming processing the M echo cancelled signals to provide B≤1 beamformed signals.

24. The method of claim 23, further comprising beamsteering processing the B beamformed signals, the beamsteering processing comprising detecting a desired-source beam signal, the desired-source beam signal representing a beam of sound wave pointing towards a desired source.

25. The method of claim 24, wherein beamsteering processing the B beamformed signals further comprises detecting an undesired-source beam signal, the undesired-source beam signal representing a beam of sound wave pointing towards an undesired source.

26. The method of claim 24, further comprising:
adaptive interference cancelling configured to provide an estimated noise signal based on at least one of the desired-source beam signal and undesired-source beam signal, and
subtracting the estimated noise signal from the desired signal to provide an output signal.

27. The method of claim 24, wherein beamsteering processing the B beamformed signals further comprises evaluating the signal-to-noise ratios of the B beamformed signals to identify the highest signal-to-noise ratio and detecting the desired-source beam signal based on the highest signal-to-noise ratio.

28. The method of claim 25, wherein beamsteering processing the B beamformed signals further comprises evaluating the signal-to-noise ratios of the B beamformed signals to identify the highest signal-to-noise ratio and detecting the desired-source beam signal based on the highest signal-to-noise ratio.

29. The method of claim 21, wherein beamsteering processing the B beamformed signals further comprises detecting the undesired-source beam signal based on the desired-source beam signal, in that the undesired-source beam signal represents a beam of sound wave pointing in an opposite direction of the desired source.

30. The method of claim 26, further comprising adaptive blocking filtering configured to process at least one of the desired-source beam signal and undesired-source beam signal and to provide an error signal for adaptive interference cancelling, the adaptive interference cancelling configured to provide an estimated noise signal based on the error signal.

31. The method of claim 23, further comprising at least one of adaptive post filtering, speech pause detecting, noise reduction filtering and automatic gain control, wherein adaptive post filtering is configured to provide a filtered output signal with reduced statistical broadband noise, automatic gain control is configured to control a signal level of the output signal and speech pause detecting is configured to detect the occurrence and non-occurrence of speech signals in the output signal or filtered output signal.

32. The method of claim 26, further comprising timely delaying the desired-source beam signal supplied before subtracting the estimated noise signal from the delayed desired signal.

33-45. (canceled)
